(19) United States
(12) Patent Application Publication
(10) Pub. No.: US 2011/0185142 A1
(43) Pub. Date: Jul. 28, 2011

(54) INFORMATION PROCESSING APPARATUS AND DATA SAVING ACCELERATION METHOD OF THE INFORMATION PROCESSING APPARATUS

(76) Inventor: Tsuyoshi Nishida, Akishima-shi (JP)

(21) Appl. No.: 12/980,629

(22) Filed: Dec. 29, 2010

(30) Foreign Application Priority Data
Jan. 26, 2010 (JP) 2010-014712

(51) Int. Cl. G06F 12/02

(52) U.S. Cl. 711/165; 711/E12.002

(57) ABSTRACT

According to one embodiment, an information processing apparatus includes a first storage, a second storage, a data saving module, and a data saving acceleration module. The data saving module is configured to save data stored in the first storage to the second storage after compressing the data stored in the first storage. The data saving acceleration module is configured to reserve a storage area on the first storage and to write predetermined data to the reserved storage area in order to fill the reserved storage area with regular data with high compression efficiency, when the data saving module saves the data stored in the first storage to the second storage.

### CROSS-REFERENCE TO RELATED APPLICATIONS

This application is based upon and claims the benefit of priority from Japanese Patent Application No. 2010-014712, filed Jan. 26, 2010; the entire contents of which are incorporated herein by reference.

### FIELD

Embodiments described herein relate generally to a data saving technique suitable for a personal computer or the like which provides a function to transition to a power saving state after compressing data in main memory and saving the compressed data in a secondary memory.

### BACKGROUND

In recent years, various information processing apparatuses such as personal computers and cellular phones have prevailed widely. Many such information processing apparatuses provide what is called a hibernation function to save the contents of a main memory in a secondary memory to allow the state prevailing upon the last power-off to be restored upon power-on. The hibernation exerts a higher power saving effect than what is called a suspend function to hold the contents of the main memory by continuing to supply power to the main memory. Thus, the hibernation is now an essential function for battery-powered information processing apparatuses.

Furthermore, the capacity of a memory installed in an information processing apparatus as a main memory has recently tended to increase. Thus, for example, a hibernation technique has been adopted in which a memory image of the main memory is compressed to create a hibernation file and store the file in the secondary memory. In this manner, various proposals have been made for hibernation (see, for example, Jpn. Pat. Appln. KOKAI Publication No. 10-333997).

The hibernation technique disclosed in Jpn. Pat. Appln. KOKAI Publication No. 10-333997 narrows down a target storage area in the main memory for saving in the secondary memory by limiting the target storage area to an area in use. This reduces the amount of transferred data to accelerate the hibernation.

More specifically, when the state transitions to power saving (idle state), software provided to accelerate the hibernation reserves and considers a storage area in the main memory to be free space. The software then notifies a hibernation file creation module (specifically, the Basic Input/Output System [BIOS]) of the reserved storage area. Upon receiving the notification, the hibernation file creation module creates a hibernation file intended only for the storage areas other than the storage area of which the module has been notified. That is, the hibernation is achieved by updating a part of the process procedure executed by the hibernation file creation module, which is a BIOS module.

However, the current operating system (OS) itself creates a hibernation file. Thus, it is difficult to avoid including the hibernation file with the particular area (the above-described free space) in the main memory, that is, to update a part of the process procedure executed by the hibernation file creation module, which is a OS module. Hence, the existing techniques including Jpn. Pat. Appln. KOKAI Publication No. 10-333997 described above fail to accelerate hibernation.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary diagram showing the system configuration of an information processing apparatus according to an embodiment.

FIG. 2 is an exemplary conceptual diagram illustrating the basic principle of acceleration of hibernation executed by the information processing apparatus according to the embodiment.

FIG. 3 is an exemplary diagram showing an example of a hibernation acceleration setting screen displayed on the information processing apparatus according to the embodiment.

FIG. 4 is an exemplary timing chart showing the cooperation between an OS and an accelerated hibernation utility program during hibernation transition in the information processing apparatus according to the embodiment.

FIG. 5 is an exemplary timing chart showing the cooperation between the OS and the accelerated hibernation utility program during hibernation recovery in the information processing apparatus according to the embodiment.

FIG. 6 is an exemplary flowchart showing an operational procedure executed by the information processing apparatus according to the embodiment during hibernation transition.

FIG. 7 is an exemplary flowchart showing an operational procedure executed by the information processing apparatus according to the embodiment during hibernation recovery.

### DETAILED DESCRIPTION

Various embodiments will be described hereinafter with reference to the accompanying drawings.

In general, according to one embodiment, an information processing apparatus includes a first storage, a second storage, a data saving module, and a data saving acceleration module. The data saving module is configured to save data stored in the first storage to the second storage after compressing the data stored in the first storage. The data saving acceleration module is configured to reserve a storage area on the first storage and to write predetermined data to the reserved storage area in order to fill the reserved storage area with regular data with high compression efficiency, when the data saving module saves the data stored in the first storage to the second storage.

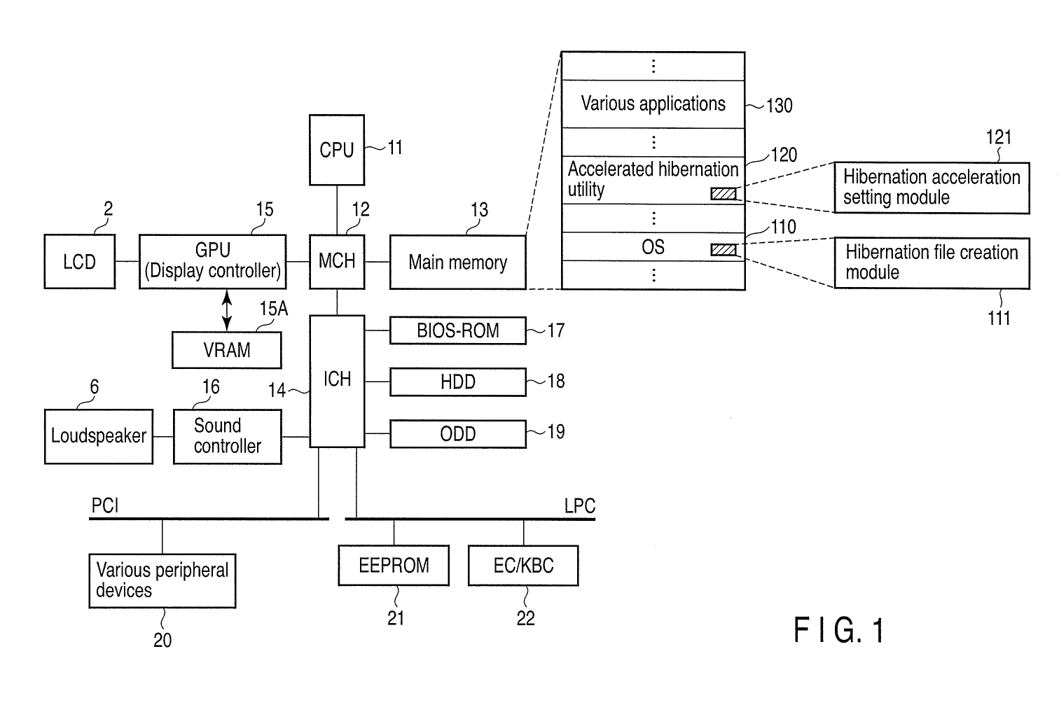

FIG. 1 is an exemplary diagram showing the system configuration of an information processing apparatus according to the embodiment. The information processing apparatus according to the embodiment is implemented as a personal computer.

As shown in FIG. 1, the information processing apparatus includes a central processing unit (CPU) 11, memory controller hub (MCH) 12, main memory 13, I/O controller hub (ICH) 14, graphics processing unit (GPU) 15, video memory (VRAM) 15A, sound controller 16, Basic Input/Output System read-only memory (BIOS-ROM) 17, hard disk drive (HDD) 18, optical disk drive (ODD) 19, various peripheral devices 20, electrically erasable programmable read-only memory (EEPROM) 21, and embedded controller/keyboard controller (EC/KBC) 22.

The CPU 11 is a processor configured to control the operation of the information processing apparatus. The CPU 11 executes various programs loaded from the HDD 18 or ODD 19 into the main memory 13. The various programs executed by the CPU 11 include an OS 110 configured to manage resources, an accelerated hibernation utility program 120 executing under control of the OS 110 as described below, and various application programs 130. Furthermore, the CPU 11 also executes the BIOS stored in the BIOS-ROM 17. The BIOS is configured to control hardware.

The MCH 12 operates as a bridge that connects the CPU 11 and ICH 14 together and also as a memory controller that controls accesses to the main memory 13. Furthermore, the MCH 12 provides a function to communicate with the GPU 15.

The GPU 15 is a display controller configured to control a display device incorporated in or connected to the information processing apparatus. The GPU 15 includes the VRAM 15A and an accelerator configured to draw images intended by various programs to be displayed, instead of the CPU 11.

The ICH 14 includes a built-in Integrated Device Electronics (IDE) controller configured to control the HDD 18 and ODD 19. The ICH 14 also controls the various peripheral devices 20 on a Peripheral Component Interconnect (PCI) bus. Furthermore, the ICH 14 provides a function to communicate with the sound controller 16.

The sound controller 16 is a sound source device configured to output audio data intended by various programs to be reproduced, to loudspeakers or the like incorporated in or connected to the information processing apparatus.

The EEPROM 21 is a memory device in which is stored, for example, identification data and environment setting data on the information processing apparatus. The EC/KBC 22 is a single-chip microprocessing unit (MPU) in which an embedded controller and a keyboard controller are integrated; the embedded controller is configured to manage power, and the keyboard controller is configured to control data input carried out by operating a keyboard, a pointing device, and the like.

The OS 110 operated on the information processing apparatus with the above-described system configuration includes a hibernation file creation module 111 as shown in FIG. 1. The hibernation file creation module 111 creates a hibernation file that holds save data obtained by compressing data in the main memory 13. The OS 110 provides a function to transition the information processing apparatus to a power saving state (idle state) after storing the hibernation file created by the hibernation file creation module 111 on the HDD 18. To recover the information processing apparatus from the power saving state (idle state), the OS 110 reads the hibernation file from the HDD 18 and decompresses and puts, in the main memory 13, the save data in the hibernation file. The OS 110 thus restores the information processing apparatus to the state prevailing before the apparatus transitions to the power saving state (idle state).

The accelerated hibernation utility program 120 is provided to accelerate the hibernation (in the present embodiment, the hibernation is performed by the OS 110). The principle of acceleration of the hibernation performed by the accelerated hibernation utility program 120 will be described below. The accelerated hibernation utility program 120 includes a hibernation acceleration setting module 121 as shown in FIG. 1.

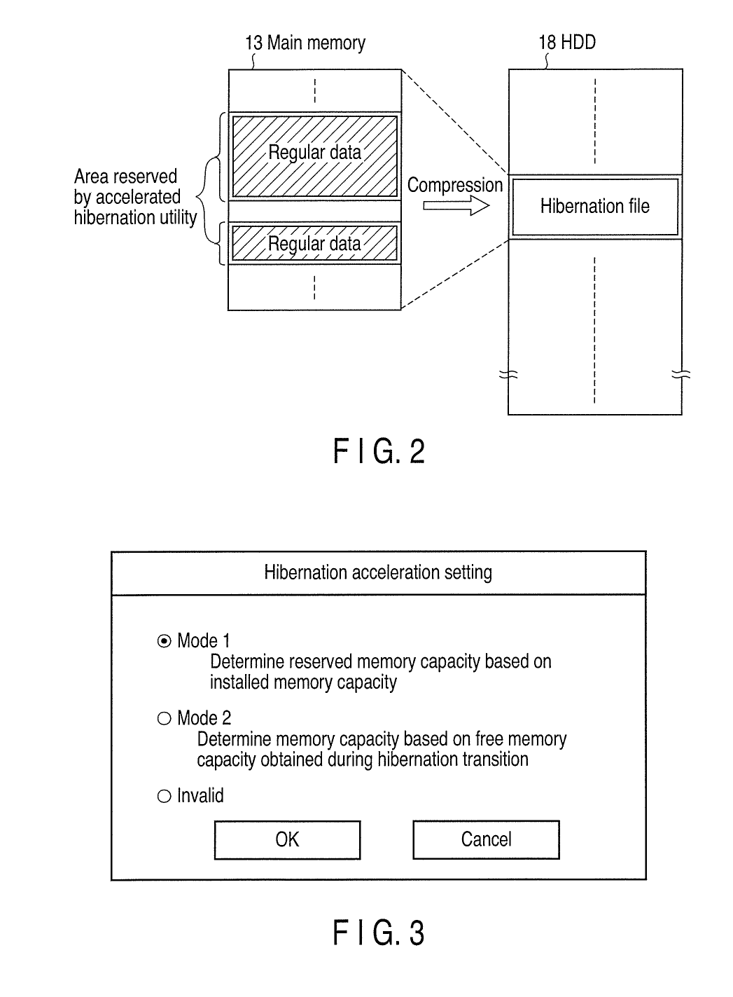

FIG. 2 is an exemplary conceptual diagram illustrating the basic principle of acceleration of the hibernation executed by the information processing apparatus.

The accelerated hibernation utility program 120 is incorporated in the information processing apparatus as a resident program. Thus, if the information processing apparatus transitions to the power saving state (idle state) or recovers from the power saving state (idle state), the accelerated hibernation utility program 120, which is executing, is notified of that by the OS 110. Here, the former case is referred to as a hibernation transition notification. The latter case is referred to as a hibernation recovery notification. For example, upon receiving the hibernation transition notification, executing programs immediately suspend processing. When the suspension of the processing is completed, the programs return data indicative of the completion to the OS 110. Here, this notification is referred to as suspension preparation completion notification. Upon receiving the suspension preparation completion notification from all executing programs, the OS 110 transitions the information processing apparatus to the power saving state (idle state).

As described above, in transitioning the information processing apparatus to the power saving state (idle state), the OS 110 allows the hibernation file creation module 111 to create a hibernation file that holds save data obtained by compressing data in the main memory 13 and then store the file on the HDD 18. Thus, upon receiving a hibernation transition notification from the OS 110, the accelerated hibernation utility program 120 requests the OS 110 to reserve a storage area in the main memory 13. The accelerated hibernation utility program 120 further executes a write process of filling the reserved storage area in the main memory 13 with regular data with high compression efficiency. Various values, for example, “0” and a low value (all bits off) may be used as the regular data. After the filling of the regular data is completed, the accelerated hibernation utility program 120 returns a suspension preparation completion notification to the OS 110.

It is expected that there is a great difference in the capacity of a hibernation file created by the hibernation file creation module 111 between before and after the filling of the regular data. More specifically, the capacity of a hibernation file created if the regular data is filled into the storage area is expected to be substantially smaller than that of a hibernation file otherwise created. This enables a reduction in file access (write and read of the hibernation file to and from the HDD 18) time during hibernation transition and during hibernation recovery to accelerate the hibernation. This technique can be applied without the need to update the process procedure executed by the hibernation file creation module 111, provided in the OS 110. Furthermore, the technique does not require any complicated procedure, for example, cooperation with the BIOS.

FIG. 3 is an exemplary diagram showing an example of a hibernation acceleration setting screen displayed by the hibernation acceleration setting module 121, provided in the accelerated hibernation utility program 120.

The hibernation acceleration setting module 121 is a program providing a user interface that allows a user to set a method of determining the capacity of a storage area in the main memory 13 reserved by the accelerated hibernation utility program 120. As shown in FIG. 2, the hibernation acceleration setting screen displayed by the hibernation acceleration setting module 121 includes three options: “Mode 1”, “Mode 2”, and “Invalid”.

“Mode 1” is an option that allows application of the method of determining the capacity of the reserved storage area based on the capacity of the main memory 13. “Mode 2” is an option that allows application of determining the capacity of the reserved storage area based on the free capacity of the main memory 13 during hibernation transition. Furthermore, “Invalid” is an option that allows setting for avoidance of hibernation acceleration carried out by the accelerated hibernation utility program 120. Any of various algorithms can be applied to determine the capacity both in “Mode 1” and in “Mode 2”. The accelerated hibernation utility program 120 executes a process for accelerating hibernation in accordance with the contents set by the hibernation acceleration setting module 121.

Here, the basic principle of acceleration of hibernation has been described on the assumption that the OS 100 itself creates a hibernation file, that is, the OS 110 includes the hibernation file creation module 111. However, this technique is not limited to this assumption and is reasonably applicable to the case where the BIOS creates a hibernation file. In this case, the hibernation can be sped up without the need to update a part of the process procedure of the hibernation file creation module, which is a BIOS module. That is, this method is very versatile in that the method can be applied to various environments without the need to update the existing environment.

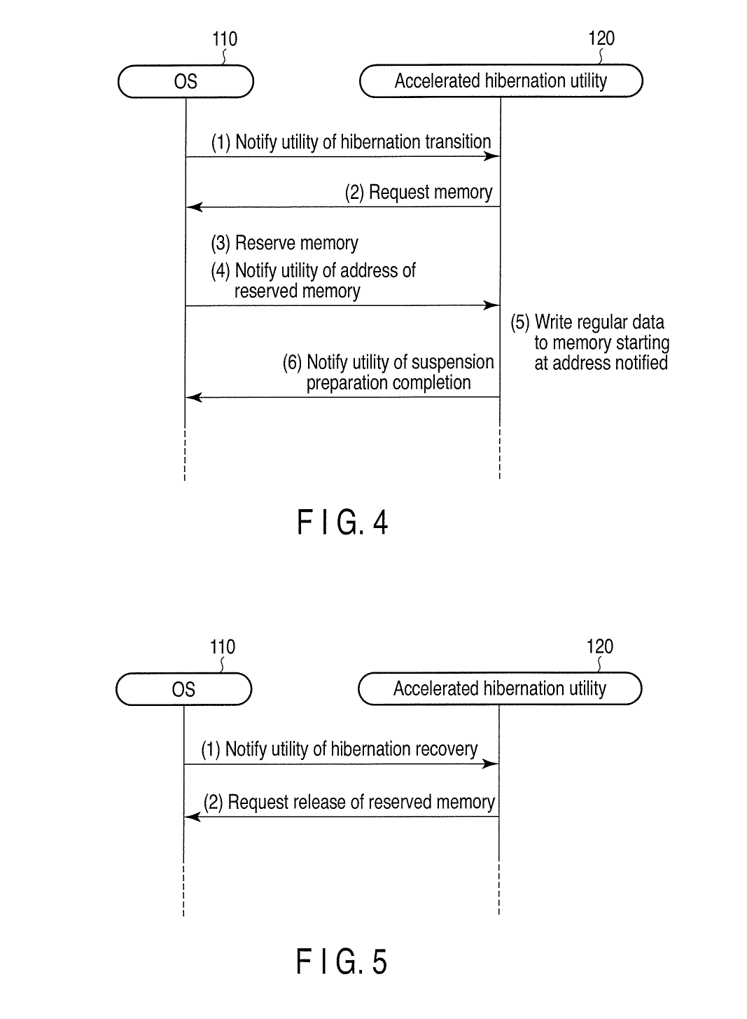

FIG. 4 is an exemplary timing chart showing the cooperation between the OS 110 and the accelerated hibernation utility program 120 during hibernation transition.

To transition the information processing apparatus to the power saving state (idle state), the OS 110 transmits a hibernation transition notification to the accelerated hibernation utility program 120, which is executing (item (1) in FIG. 4). Upon receiving the hibernation transition notification, the accelerated hibernation utility program 120 requests the OS 110 to reserve a storage area in the main memory 13 (item (2) in FIG. 4).

Upon receiving the request, the OS 110 reserves a storage area in the main memory 13 for the accelerated hibernation utility program 120 (item (3) in FIG. 4). The OS 110 then notifies the accelerated hibernation utility program 120 of the address of the reserved storage area in the main memory 13 (item (4) in FIG. 4).

Then, the accelerated hibernation utility program 120 carries out write for filling the storage area in the main memory 13 with regular data (item (5) in FIG. 4). After the filling of the regular data is finished, the accelerated hibernation utility program 120 returns a suspension preparation completion notification (item (6) in FIG. 4).

Thereafter, the OS 110 creates a hibernation file and writes the hibernation file to the HDD 18. In this case, since the regular data has been filled into the storage area, the size of the hibernation file is reduced to decrease a file access time for the HDD 18.

On the other hand, FIG. 5 is an exemplary timing chart showing the cooperation between the OS 110 and the accelerated hibernation utility program 120 during hibernation recovery.

To recover the information processing apparatus from the power saving state (idle state), the OS 110 reads the hibernation file from the HDD 18. The OS 100 decompresses the save data in the hibernation file, and then puts the decompressed save data in the main memory 13. Since the size of the hibernation file has been reduced, the file access time for the HDD 18 is also decreased during the hibernation recovery.

After restoring the information processing apparatus to the state prevailing before the apparatus transitions to the power saving state (idle state), the OS 110 transmits a hibernation recovery notification to the accelerated hibernation utility program 120, which was previously executing during hibernation transition (item (1) in FIG. 5). Upon receiving the hibernation recovery notification, the accelerated hibernation utility program 120 requests the OS 110 to release the reserved storage area in the main memory 13 (item (2) in FIG. 5).

This reliably prevents the acceleration of hibernation carried out by the accelerated hibernation utility program 120 from affecting the information processing apparatus recovered from the hibernation.

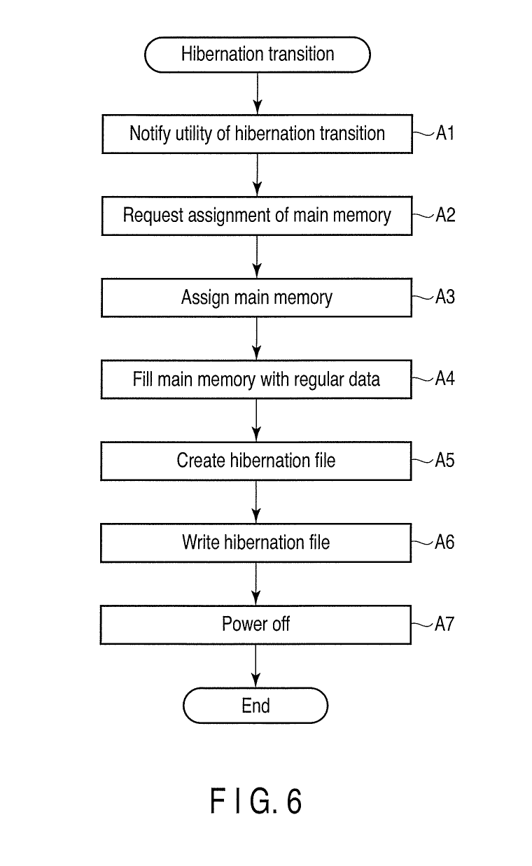

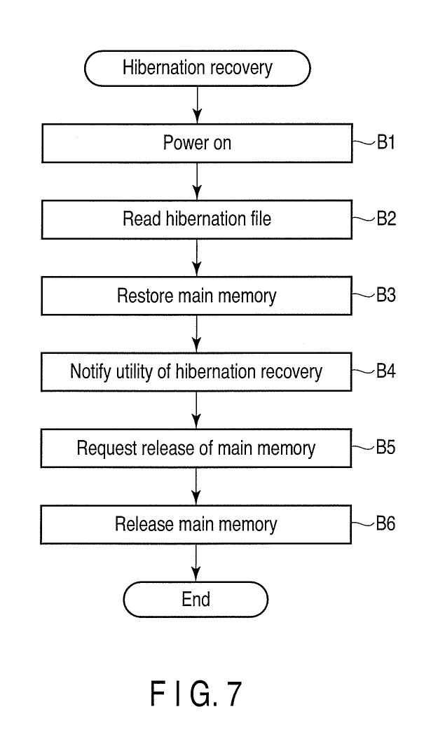

Now, operational procedures for hibernation executed by the information processing apparatus will be described with reference to FIG. 6 and FIG. 7.

FIG. 6 is an exemplary flowchart showing an operational procedure executed by the information processing apparatus during hibernation transition.

When the information processing apparatus transitions to the power saving state (idle state), first, the OS 110 transmits a hibernation transition notification to the accelerated hibernation utility program 120 (block A1). Upon receiving the notification, the accelerated hibernation utility program 120 requests the OS 110 to reserve a storage area in the main memory 13 (block A2). Upon receiving the request, the OS 110 reserves a storage area in the main memory 13 for the accelerated hibernation utility program 120 (block A3).

Then, the accelerated hibernation utility program 120 fills the reserved storage area in the main memory 13 with regular data (block A4). The OS 110 creates a hibernation file for the main memory 13 in which the regular data has been filled (block A5). The OS 110 writes the hibernation file to the HDD 18 (block A6). After the write of the hibernation file to the HDD 18 is completed, the OS 110 powers off the information processing apparatus (block A7).

FIG. 7 is an exemplary flowchart showing an operational procedure executed by the information processing apparatus during hibernation recovery.

When the information processing apparatus is powered on (block B1), the OS 110 first reads the hibernation file from the HDD 18 (block B2). The OS 110 then decompresses the save data in the hibernation file and puts the decompressed save data in the main memory 13 (block B3). After the main memory 13 is restored, the OS 110 transmits a hibernation recovery notification to the accelerated hibernation utility program 120 (block B4).

Upon receiving the notification, the accelerated hibernation utility program 120 requests the OS 110 to release the reserved storage area in the main memory 13 (block B5). Upon receiving the request, the OS 110 releases the storage area in the main memory 13 (block B6).

As described above, the information processing apparatus according to the embodiment enables hibernation to be sped up even if the OS 110 itself creates a hibernation file.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first storage;
a second storage;
a data saving module configured to save data stored in the first storage to the second storage after compressing the data stored in the first storage; and
a data saving acceleration module configured to reserve a storage area on the first storage and to write predetermined data to the reserved storage area in order to fill the reserved storage area with regular data with high compression efficiency, when the data saving module saves the data stored in the first storage to the second storage.

2. The apparatus of claim 1, wherein the data saving acceleration module is configured to determine the capacity of the storage area reserved on the first storage based on the storage capacity of the first storage.

3. The apparatus of claim 1, wherein the data saving acceleration module is configured to determine the capacity of the storage area reserved on the first storage based on the storage capacity of a free space on the first storage when the data saving module saves the data stored in the first storage to the second storage.

4. The apparatus of claim 1, further comprising a setting module configured to set a method of determining the capacity of the storage area reserved on the first storage by the data saving acceleration module.

5. The apparatus of claim 1, further comprising a data restoration module configured to restore the data to the first storage, by decompressing the data saved in the second storage,
wherein the data saving acceleration module releases the storage area reserved on the first storage device when the data restoration module restores the data to the first storage.

6. The apparatus of claim 1, wherein the data saving module comprises a module of an operating system that manages a resource of the apparatus.

7. The apparatus of claim 1, wherein:
the first storage comprises a main memory of the apparatus, and
the second storage comprises a secondary memory of the apparatus.

8. A data saving acceleration method of an information processing apparatus comprising a function to transition to a power saving mode after compressing data in a main memory and saving the compressed data to the second storage, the method comprising:
reserving a storage area on the main memory when the data in the main memory is saved; and
writing predetermined data to the reserved storage area in order to fill the reserved storage area with regular data with high compression efficiency.

9. The method of claim 8, further comprising determining the capacity of the storage area reserved on the main memory based on the storage capacity of the main memory.

10. The method of claim 8, further comprising determining the capacity of the storage area reserved on the main memory based on the storage capacity of a free space in the main memory when the data in the main memory is saved.

11. The method of claim 8, further comprising setting a method of determining the capacity of the storage area reserved on the main memory.

12. The method of claim 8, further comprising restoring the data to the main memory by decompressing the data saved in the secondary memory; and
releasing the storage area reserved on the main memory when the data in the main memory is restored.
